(19) United States
(12) Patent Application Publication
(10) Pub. No.: US 2007/0267343 A1
(43) Pub. Date: Nov. 22, 2007

(54) Heavy metal particulate emission speciation modification wet process

(76) Inventor: Keith Edward Forrester, Meredith, NH (US)

Correspondence Address: Keith Edward Forrester, 78 Tracy Way, Meredith, NH, 03253, US

(21) Appl. No.: 11/803,625

(22) Filed: May 15, 2007

Related U.S. Application Data
(60) Provisional application No. 60/800,960, filed on May 17, 2006.

(51) Int. Cl. C02F 1/02

(52) U.S. Cl. 210/600

(57) ABSTRACT

The invention pertains to a method for reducing the leaching of heavy metals from air particulate emissions. The method includes contacting the heavy metal particulate with a water and complexing agent which converts the molecular form of the particulate to a less soluble and less bioavailable form prior to collection and release to the environment. This method eliminates the need to remove or treat soils and environments exposed to particulate deposition and greatly reduces the environmental and health risks associated with the deposition of heavy metal particulate in the open environment as well as at controlled discharge areas.

### BACKGROUND OF INVENTION

The health and biological risks associated with inhalation, ingestion and dermal uptake of Heavy Metal Particulates (HMP) which contain one or more toxic metals such as Cadmium, Chromium, Silver, Lead, Arsenic, Barium, Selenium, and Mercury from point source and non-point source air emissions, wastewater discharges and water pollution sources such as storm-water runoff have been a major concern of health officials, environmental engineers, biologists, regulators and communities for many years. In addition to concerns over direct acute human and biological community exposure effects, professionals have also struggled with predictions of indirect and long-term exposed receptor effects within air emission particulate deposition and sediment collection impact areas where bioaccumulation or accumulate exposure at HMP toxic levels may occur. In response to these concerns the USEPA, OSHA and numerous other federal and state agencies have promulgated and continue to develop numerous regulations for monitoring and controlling both air and water-borne particulate emissions from fixed facilities such as municipal and industrial waste incinerators, wood incinerators, medical waste incinerators, hazardous waste incinerators, primary and secondary smelters, auto shredders, wire choppers, foundries, steel mills, coal and oil fuel power plants, oil refineries, and numerous other industrial and commercial point source emissions, as well as from non-point source emissions such as roofs, parking lots and highways. Regulations under the Clean Air Act (CAA), National Pollution Discharge Elimination System (NPDES), Resource Conservation and Recovery Act (RCRA) and Comprehensive Environmental Response, Compensation, and Liability Act (CERCLA-a.k.a. Superfund) and other related emission and HMP regulations are extensive, complex, and have great impact on industrial, commercial and construction operations generating and/or managing regulated contaminants including HMP.

The current Air Pollution Control (APC) and Wastewater/Water Sediment Control (WSC) methods use chemical-physical or physical means and are presumptive in design, i.e., the capture of HMP in APC baghouse filtration, cyclone collection, and filter particulate capture devices and the capture of WSC particulates and flocculated particulates using activated carbon, adsorptive filtration, sand and media fitration, fabric and paper filtration, gravimetric and/or cyclonic means, presumes high HMP and Particulate Matter less than 10 micron (PM10) capture rates (99.99% and 50%+respective) and consequently ignores the need for engineering collection processes with anticipation of release of sub-micron and above one micron small HMP during normal operations and all HMP loading during control unit upset conditions where capture is bypassed. In many APC devices used for both acid gas and particulate control, dry hydrated lime (Ca(OH)₂) or slaked quicklime (CaO) slurry is used as an injected chemical agent to convert acid gases such as sulfur dioxide and HCL to solid calcium salts such as CaSO4 or CaCl2 prior to physical capture devices such as baghouse filters, yet this same addition of lime produces heavy metal oxides within particulate lead and other metals which then increases the leachabiity and bioavailability of the fine uncontrolled heavy metal particulate emissions from the air source which are not captured by the filtration capture devices. To further complicate the matter, these fine particulate releases are now also more bioavailable as they are more readily inhaled and ingested as well as have a high surface area to weight ratio than collected fines, and thus are most in need of being in a non-toxic and low leachable form. Consequently, certain APC devices and technologies solve one problem, large particulate and acid gas release, while producing another, chemically altered small particulate in highly toxic form.

The current air pollution control technologies thus control mass release to the environment which provides for reduction of toxicity from HMP loading, yet fail to modify released HMP fractions to forms which are least bioavailable. Accordingly, there exists a need to augment HMP APC processes with a HMP Bioavailability Conversion Means (BCM), thus assuring that the anticipated and unanticipated releases of HMP from APC units such as electrostatic precipitators, baghouse filters, cyclones, are in a form which are least bioavailiable.

U.S. Pat. No. 6,186,939 B1 discloses the method of stabilizing heavy metals during production and prior to collection as waste. The method does not disclose the means of stabilization of discharged particulates prior to emission not collected as waste or materials.

U.S. Pat. No. 5,193,936 discloses a two-step means of stabilization of particulate wastes. The method dose not disclose the means of stabilization of particulates in an in-line one-step method of particulates prior to emission not collected as waste or material.

U.S. Patent Application 2002/0022756 A1 discloses a means for reducing bioavailability from particulate waste through use of amended phosphates and increased temperature. The method does not disclose the means of stabilization of discharged particulates prior to emission not collected as waste or materials.

### SUMMARY OF THE INVENTION

This invention relates to the method of reducing leachability and bioavailability of HMP matter in air prior to the emission of such matter from point sources sources. The preferred method of reducing bioavailability will be through contacting HMP with at least one heavy metal complex forming agent and water such that effective contact time, water matrix, temperature and turbulence exists to allow such new mineral complexing to form such that the newly formed heavy metal complex(s) exhibit lower solubility and thus lower bioavailability either under natural or induced leaching and/or under stomach acid digestion in humans and/or animals. The heavy metal complex would be formed prior to emission of the particulate matter to open environment by contacting the heavy metal particulate with a complexing agent(s) in the presence of water, from heavy metal complex groups including iodides, carbon, activated carbon, activated alumina, ferric sulfate, ferric chloride, ferrioxyhydroxide, sulfur, phosphates, phosphonates, polyphosphates, fertilizer phosphates, bone animal and fish phosphates, diatoms, sulfates, carbonates, sulfides, silicates, boron, cements, polymers, magnesium and its oxides, calcium and its oxides, iron, aluminum, surfactants, mineral precipitant agents and combinations thereof. The complexing method provides for reducing TCLP (Method 1311), Simulated Precipitant Leaching Procedure (SPLP-Method 1310 which simulates rainwater leaching), Japan DI (uses acid adjusted DI water for 6 hours to simulate rainwater leaching), Swiss sequential DI (uses sequential DI water leaching to simulate rainwater), rainwater and other related leaching of heavy metals from the HMP treated according to the method, and also reduces bioavailablity of such particulate matter upon exposure to stomach acids of animals, humans or other biological exposures. The method includes contacting the HMP prior to emission and preferably prior to process particulate collection devices with at least one complexing agent and water such that particulate matter has reduced heavy metal leaching potential prior to collection and generation as a regulated waste and prior to exposure to the environment, particulate deposition area and/or biological community.

This invention has the advantage of reducing the solubility and bioavailability of heavy metals upon first generation of the particulates as a contaminant into the environment. This method also allows the HMP exposed soils/materials in stack emission or point source discharge locations to remain below TCLP levels and thus such impacted areas exempt from RCRA and other relevant hazardous waste regulation. This pre-emission particulate complexing method also assures control of heavy metal leaching and reduction of ecological and human exposure risks by creation of immediate upon-contact water and stomach acid insoluble complex(s). The desired particulate complex produced would be specifically engineered for the source emission character and receptor risks. For example, Pb and As particulate stack emissions and facility releases from a primary or secondary lead smelter would be complexed prior to release from the facility stacks and emission points to mineral complexes such as Pb5(PO4)3Cl (chloropyromorphite), Pb3(PO4)2 (lead phosphate), arsenic mimetite, ferric arsenate, lead silicates, corkite, plumbogummite, and other relatively insoluble lead and arsenic complex minerals which have significantly less mobility and toxicity than the particulate lead and arsenic form as elemental, lead oxide, arsenate, arsenite or lead chloride. The point of application into the smelter would likely be after the furnace in a spray tower thus allowing for mineral formation in water matrix, before baghouse or other particulate collection. The invention provides a means to control metal solubility both under regulatory testing such as TCLP, SPLP, DI, EP TOX, Japan DI, Swiss DI, for disposal and/or hazardous waste classification of collected particulate now at its first “point of generation” and thus regulated as a waste, as well as reducing bioavailability of the un-collected fine and upset condition released emissions in the open environment, without significantly modifying the particulate physical character thus providing for continued use of particulate capture devices such as filters which rely upon free flowing nature of emission fines and non-caking on filters. Depending on the path of APC fines collection such as boiler ashes and furnace ashes which may be routed into wet bath collection with bottom ashes and slags, the method would also benefit the reduction of solubility of heavy metals within those heavier ash streams prior to such generation and regulation as waste material.

The preferred method provides for HMP complexing within a water spray pattern or tower prior to filtration collection in order that the existing facility point source particulate controls remain effective and that compliance with Clean Air Act (CAA) stack emission regulations on total stack particulate emission loading and PM10 loading be maintained. One negative of adding water spray and complexers to the discharge side of the particulate collection devices such as at the base of an air emission stack is that the HMP complexing agent could increase total stack or oultet emission particulate loading and PM10 loading to levels above allowed and modeled for the specific stack emission and will also remain less effective due to the limited time, lower temperature and lower turbulence contact within the stack flue. Another major negative impact on APC units is the likely adverse impacts additional particulate injection and water will have on reducing flue gas buoyancy, temperature and plume rise and increased in-stack particulate settling, as most commercially available dry complexing agents are of particulate size near or above 200 mesh and thus would not entrain properly in the flue gas and thus settle within the stack as well as cause localized settling in violation of area particulate loading allowances under OSHA and the CAA. Wet complexing agents or slurried agents may be used post-filtration, but similar reduction of flue gas temperature and gas buoyancy as modeled for CAA permitting would likely direct engineers to utilize agent and water injection prior to baghouse and/or cyclone particulate collection.

### DETAILED DESCRIPTION OF THE INVENTION

HMP complexing is herein defined as reducing the solubility and thus bioavailability of heavy metal bearing particulates from air emission sources. The confirmation of leaching reduction can be determined by performing a suitable leaching test on the particulate and optional methods by physical evaluations of mineral formation under selective electron microscopy (SEM), x-ray diffraction (XRD) or chemical extraction techniques.

Heavy Metal Particulate (HMP) can be in a variety of molecular forms including elemental, anionic or cationic form. The most common molecular form of HMP from point-sources such as municipal solid waste refuse incinerators, wood incinerators, fossil fuel combustors, primary and secondary smelters, metal casting shops and foundries, shredders, steel mills and non-point sources such as highways, parking lots, and roofs are as an oxide, sulfate or chloride. Many HMP sources are in a molecular and physical form designed by the HMP generating facility environmental engineer to achieve large particle capture in APC filtration units. Such engineering does not include methods for HMP uncollected exposure control to receptors such as fish, humans, plant and crops uptake area, and animals. Soils and materials subjected to HMP deposition such as residential and crop field soils surrounding smelters and refuse incinerators can for example contain as high as 2500 ppm compositional lead and 50 ppm TCLP leachable lead from long-term constant air stack particulate emission deposition and accumulation.

Leach test conditions, as defined herein, include the conditions to which a material or soil impacted by HMP release and deposition is subjected during dilute acetic acid leaching (TCLP), buffered citric acid leaching (STLC), distilled water, synthetic rainwater or carbonated water leaching (US SPLP, Japanese and Swiss and SW-924). Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. Leachable heavy metals, contained in the waste, then complex with citrate anions to form lead citrate. The concentration of leached metals are then analyzed by Inductively-Coupled Plasma (ICP) after filtration of a 100 ml aliquot from the tumbler through a 45 micron glass bead filter. A WET result of ≧5 ppm lead for example will result in a waste determination as hazardous in California.

According to the methods of the invention, HMP can be complexed by contact with at least one complexing agent and water at sufficient dosage, temperature, turbulence and duration to allow for complexing of relatively soluble heavy metals to relatively insoluble complex forms prior to emission. The amount of complexing agent and water incorporated with the HMP will be that which is effective in reducing the leaching of heavy metals from the particulate as needed, for example to a level no more than 5.0 ppm lead, as determined in an EPA TCLP test performed on the particulate or material receiving the particulate as set forth in the Federal Register, Vol. 55, No. 126, pp. 26985-26998 (Jun. 29, 1990), or other leaching test relating to receptor exposures, digestive capacity and or bioaccumulation. Regardless of the receptor, complexing HMP to a less soluble form will directly reduce exposed receptors and environmental health and biological impact risks.

The complexing agent and water can be incorporated within or applied to the HMP by in-line slurry injection or wet chemical injection prior to or after HMP capture units, bath contact, spray, or other application means. Depending on the HMP discharge system such as tall air exhaust stacks (such as Good Engineering Practice (GEP) height required under the CAA at new and modified point air emission sources) application of HMP complexer and water can be added to the discharge side of the APC devices, thus avoiding possible chemical-physical complications with augmentation of the APC unit operation with a HMP complexer. As many APC systems are precisely designed for the process feed character and chemistry, post-collection HMP complexing as a polishing unit may be best suited for existing control units. It also remains possible that the HMP complex agent may be optimally applied during formation of the heavy metal particulate prior to emission in the production process such as within the furnace firebox, within scrubbing acid gas application units, within primary shredders, and at other locations permitting introduction of complexers and water to convert particulate metals to non-leachable complex form(s). Given that the particulate surface is the primary exposure area to the environment and that the complex surface will likely reduce or significantly retard diffusion from the particulate core, the stabilization of the HMP surface alone is offered as one optional control which also provides for use of field spray post-stack air pollution control devices that can be applied to existing operations not utilizing heavy metal complexing during production.

The invention provides a means to control metal solubility both under regulatory testing such as TCLP testing for hazardous waste classification as well as reducing bioavailability in the open environment without significantly modifying the particulate physical character thus providing for continued use of particulate capture devices such as filters which rely upon free flowing nature of emission fines and non-caking on filters. The preferred method provides for HMP complexing prior to filtration collection in order that the existing facility point source particulate controls remain effective and that compliance with Clean Air Act (CAA) stack emission regulations on total stack particulate emission loading and PM10 loading are complied with. The likely negative impact of adding complexers to the discharge side of the particulate collection devices is that the HMP complexing agent and water could increase measurable total stack emission particulate loading and PM10 loading to levels above allowed and modeled for the specific stack emission, and may also remain less effective than pre-APC application due to the limited time and limited turbulence within the stack flue alone. Another major issue relates to the likely adverse impacts additional particulate and carrying agents of ambient air or water will have on flue gas buoyancy and temperature and possible reductions of stack plume rise. Wet complex agents or slurry agents may be used post-filtration, but similar reduction of flue gas temperature and gas buoyancy as modeled for CAA permitting would likely direct engineers to utilize agent and water injection prior to filtration.

In one embodiment of the invention, the heavy metal bearing particulate from an air emission point source is contacted with a complexing agent and water from the phosphate group in-line prior to exhaust of air emissions from the facility stack. The introduction of phosphates and water into the facility emission stream permits the particulate emissions contact with the introduced PO4 complexing sources and thus converts Pb, Cd, As, Cu, Hg and Zn fine particulates and associated metal oxides and chlorides to phosphate complexed metals which are substantially less soluble and less bioavailable. The introduction of the phosphate complex and water with or without additional complex agents depends on the emission heavy metal compositions and can also be selected by the designer depending on desired contact time and observed complex formation conditions such as temperature, mixing energy and retention variations such as contact time on fabric filters prior to automatic cleaning cycles. The point of complex agent introduction into the air pollution control process will also depend on the particulate size and loading introduced by the complexing agent and the determination as to whether the existing point source particulate and PM10 loading allowances under the CAA will permit complex agent introduction prior to or after particulate control devices. Since most facility stack emissions are closely allowed under CAA permitting and that emission rates are monitored, it is more likely that environmental engineers will elect to introduce complex agents and water prior to APC filtration devices thus not directly increasing particulate loading or reducing exhaust temperatures and entrainment flue buoyancy.

The option to utilize various complexing agents and various points of application provides the environmental engineer flexibility in stabilizing agent recipe selection, with a preferred choice responding to facility stack emission permits, modeling methods and assumptions and the site and use criteria such as TCLP, DI or other biological based toxicity criteria.

The use of water and engineered phosphates such as wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), trisodium phosphate, polyphosphates, tetrapotassium phosphate, dicalcium phosphate, tricalcium phosphate, calcium orthophosphates, and combinations thereof would, as an example, provide various amount of phosphate contact with particulates. In certain cases such as use of amber and green acid, such acids embody sulfuric acid, vanadium, iron, aluminum and other complexing agents which could provide for a single-step formation of complex minerals with particulate metals such as lead, cadmium, zinc, copper, arsenic and chromium. The water and phosphate group chemical size, dose rate, contact duration, and application means could be engineered for each type of particulate and process generating the particulate.

As an example, when lead comes into contact with the Pb complexing agent(s) and water, low water soluble compound(s) begin to form, typically a mineral phosphate or precipitate formed through substitution or surface bonding, which is less soluble than the lead originally in the particulate matter. For example, the mineral apatite lead phosphate Ca₄(Pb)(PO₄)₃ OH, lead phosphate Pb₃(PO₄)₂, lead silicate Pb₂(SlO₃), lead sulfide PbS, chloropyromorphite Pb5(PO)4Cl, corkite and plumbogummite can be formed by adding respective precipitating agents with complexing agents to the particulate. It also remains possible that modifications to temperature and pressure may accelerate of assist formation of lead minerals and complexes, although such methods are not considered optimal for this application given the need to limit cost and provide for optional field based complexing operations that would be complicated by the need for pressure and temperature control devices and vessels. Use of complex agents for mineral formation of lead bearing wastes post-generation is taught by U.S. Pat. No. 5,722,928 issued to Forrester.

Examples of suitable arsenic, mercury, lead, cadmium, chromium, copper and zinc stabilizing agents include, but are not limited to, iodide, hydroxyapatite, activated alumina, activated carbon, bone char, potassium and alumunium salts, ferrioxyhydroxide, potassium permanganate in combination with ferric sulfate or ferric chloride, alum, aluminum sulfate, ferric chloride, ferric sulfate, phosphate fertilizers (e.g., MAP, DAP, SSP, TSP), phosphate rock, pulverized phosphate rock, calcium orthophosphates, monocalcium phosphate, dicalcium phosphate, tricalcium phosphate, trisodium phosphates, phosphate fertilizers, dolomitic limestone, hydrated limestone, calcium oxide (quicklime), calcium carbonates, magnesium oxides, silicates, sodium metasilicates, potassium silicates, natural phosphates and lead mineralizing agents and combinations of the above, phosphoric acids, green phosphoric acid, amber phosphoric acid, black phosphoric acid, merchant grade phosphoric acid, Coproduct solution, hypophosphoric acid, metaphosphoric acid, hexametaphosphate, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The amounts of water and heavy metal complexing agent used, according to the method of invention, depend on various factors including limitations under CAA as well as APC process limitations, particulate character, desired solubility reduction potential, desired complex toxicity, and desired complex formation relating to toxicological and site environmental control objectives. It has been found that an amount of certain complex agents such as activated alumina, bone char, activated carbon, aluminum sulfate, ferric sulfate, ferric chloride, sodium silicate, hydroxyapatite, hexametaphosphate, dicalcium phosphate, tricalcium phosphate, monocalcium phosphate, triple superphosphate, Portland cement, reactive limestone, calcium oxide, diatomaceous earth, pulverized triple superphosphate, wet process amber phosphoric acid, and magnesium oxide, equivalent to between about 0.1% and about 15% by weight of particulate emission is sufficient for TCLP complexing of HMP refuse incinerator flyash, electric arc furnace dust, brass foundry flyash, secondary smelter flyash, shredder dust, utility stormwater fines. However, the foregoing is not intended to preclude yet higher or lower usage of water and complex agent or combinations if needed since it has been demonstrated that amounts greater than 15% complexing agent and 15% water by weight of particulate also work, but are more costly.

The examples below are merely illustrative of this invention and are not intended to limit it thereby in any way.

### EXAMPLE 1

In this example, municipal solid waste incinerator flyash and scrubber residue fines, collected by baghouse collection devices, ranging from 1.0 to 50.0 micron particulate size containing TCLP and water soluble Pb and Cd were complexed with varying amounts of water and agents including hydroxyapatite (HAP), Dicalcium Phosphate (DCP), Tricalcium Phosphate (TCP), Hexametaphosphate (HMP), activated carbon (AC), amber phosphoric acid (WAA), pulverized triple superphosphate (TSP) and pulverized magnesium oxide powder (MGO). Complexed and un-complexed particulate samples were subsequently tested for TCLP and DI leachable Pb and Cd. Particulates were extracted according to TCLP procedure set forth in Federal Register, Vol. 55, No. 126, pp. 26985-26998 (Jun. 29, 199), which is hereby incorporated by reference, and water extraction by substituting deionized water for the TCLP extraction fluid solution. This test procedure is also referenced in 40 C.F.R. 260 (Appendix 2) and EPA SW 846, 3^{rd} Edition. The retained leachate was digested prior to analysis by ICP.

TABLE 1
REFUSE INCINERATOR FLYASH

| Complexer/Water Dose (%) | Pb TCLP/DI (ppm) | Cd TCLP/DI (ppm) |
|---|---|---|
| 0/10 | 54.0/5.6 | 1.4/0.05 |
| 2/10 HAP | ND/ND | ND/ND |
| 5/10 DCP | ND/ND | ND/ND |
| 5/10 TCP | ND/ND | ND/ND |
| 5/10 HMP | 0.60/1.80 | 0.30/ND |
| 5/10 AC | 0.09/ND | 0.54/0.05 |
| 5/10 WAA | ND/ND | ND/ND |
| 5/10 TSP | ND/ND | ND/ND |
| 5/10 MgO | 1.2/0.05 | 0.05/0.05 |

### EXAMPLE 2

In this example, electric arc furnace dust fines at 1.0 to 50.0 micron containing soluble Pb, and Zn were complexed with varying amounts of water and agents including amber phosphoric acid (WAA), pulverized triple superphosphate. Complexed and un-complexed particulate samples were subsequently tested for TCLP and DI leachable Pb and Zn. Particulates were extracted according to TCLP procedure set forth in Federal Register, Vol. 55, No. 126, pp. 26985-26998 (Jun. 29, 199), which is hereby incorporated by reference, and water extraction by substituting deionized water for the TCLP extraction fluid solution. This test procedure is also referenced in 40 C.F.R. 260 (Appendix 2) and EPA SW 846, 3^{rd} Edition. The retained leachate was digested prior to analysis by ICP.

TABLE 2
ELECTRIC ARC FURNACE DUST

| Complexer/Water Dose (%) | Pb TCLP/DI (ppm) | Zn TCLP/DI (ppm) |
|---|---|---|
| 0/10 | 367/38.5 | 1300/50 |
| 5/10 WAA | 2.5/0.05 | 16/0.05 |
| 5/10 TSP | 5.9/0.05 | 58/0.05 |

### EXAMPLE 3

In this example, brass foundry flyash fines at 1.0 to 100.0 micron containing soluble Pb were complexed with varying amounts of water and agents including amber phosphoric acid (WAA), pulverized triple superphosphate (TSP) and pulverized magnesium oxide powder (MGO). Complexed and un-complexed particulate samples were subsequently tested for TCLP and DI leachable Pb. Particulates were extracted according to TCLP procedure set forth in Federal Register, Vol. 55, No. 126, pp. 26985-26998 (Jun. 29, 199), which is hereby incorporated by reference, and water extraction by substituting deionized water for the TCLP extraction fluid solution. This test procedure is also referenced in 40 C.F.R. 260 (Appendix 2) and EPA SW 846, 3^{rd} Edition. The retained leachate was digested prior to analysis by ICP.

TABLE 3
BRASS FOUNDRY FLYASH

| Complexer/Water Dose (%) | Pb TCLP/DI (ppm) |
|---|---|
| 0/10 | 32.0/1.3 |
| 5/10 WAA | 0.05/0.05 |
| 5/10 TSP | 0.05/0.05 |
| 5/10 MgO | 0.05/0.05 |

### EXAMPLE 4

In this example, smelter flyash fines at 1.0 to 50.0 micron containing soluble As and Pb were complexed with varying amounts of water and agents including Activated Alumina (AA), potassium permanganate and ferric sulfate (KM+FS), ferric sulfate (FS), amber phosphoric acid (WAA), and pulverized triple superphosphate (TSP). Complexed and un-complexed particulate samples were subsequently tested for TCLP and DI leachable Pb. Particulates were extracted according to TCLP procedure set forth in Federal Register, Vol. 55, No. 126, pp. 26985-26998 (Jun. 29, 199), which is hereby incorporated by reference, and water extraction by substituting deionized water for the TCLP extraction fluid solution. This test procedure is also referenced in 40 C.F.R. 260 (Appendix 2) and EPA SW 846, 3 Edition. The retained leachate was digested prior to analysis by ICP.

TABLE 4
SMELTER FLYASH

| Complexer/Water Dose (%) | Pb TCLP/DI (ppm) | As TCLP (ppm) |
|---|---|---|
| 0/10 | 683/15.6 | 460 |
| 5/10 WAA | 0.05/0.05 | 320 |
| 5/10 TSP | 0.05/0.05 | 350 |
| 5/10 KM + 5/10 FS | 467/NT | 1.2 |
| 510 FS | 560/NT | 44 |
| 5/10 KM + 5/10FS + 2 WAA | ND/NT | 0.90 |

### EXAMPLE 5

In this example, wire shredder dust fines at 1.0 to 50.0 micron containing soluble Pb were complexed with varying amounts of water and agents including amber phosphoric acid (WAA), pulverized triple superphosphate (TSP) and pulverized magnesium oxide powder (MGO). Complexed and un-complexed particulate samples were subsequently tested for TCLP and DI leachable Pb. Particulates were extracted according to TCLP procedure set forth in Federal Register, Vol. 55, No. 126, pp. 26985-26998 (Jun. 29, 199), which is hereby incorporated by reference, and water extraction by substituting deionized water for the TCLP extraction fluid solution. This test procedure is also referenced in 40 C.F.R. 260 (Appendix 2) and EPA SW 846, 3^{rd} Edition. The retained leachate was digested prior to analysis by ICP.

TABLE 5
SHREDDER DUST

| Complexer/Water Dose (%) | Pb TCLP/DI (ppm) |
|---|---|
| 0/10 | 12.0/0.05 |
| 5/10 WAA | 0.05/0.05 |
| 5/10 TSP | 0.05/0.05 |
| 5/10 MgO | 0.35/0.05 |

The foregoing results readily established the operability of the present process to complex heavy metals particulate thus reducing leachability and thus bioavailability. Given the effectiveness of the complexing agents as presented in the Table 1 thru 6, it is believed that an amount of the stabilizing agents equivalent to less than 1% by weight of particulate emission with water at less than 10% weight particulate should be effective.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility and bioavailability of heavy metals within particulate air emissions comprising contacting heavy metal particulate with at least one complexing agent and water source in an amount effective in reducing the leaching of heavy metal from particulate and thus reducing particulate solubility and bioavailability.

2. The method of claim 1, wherein the heavy metal complexing agent is selected from the group consisting of precipitants, coagulants, buffer agents, oxidizing agents, reducing agents, magnesium oxide, calcium oxide, Portland cement, iodide, potassium iodide, carbon, activated carbon, bone char, activated alumina, aluminum sulfate, potassium permanganate, ferric chloride, ferric sulfate, sulfides, carbonates, silicates, water soluble phosphates, water insoluble phosphates, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, monocalcium phosphate, monoammonia phosphate, diammonium phosphate, dicalcium phosphate, tricalcium phosphate, trisodium phosphate, salts of phosphoric acid, and combinations thereof.

3. The method of claim 2, wherein the salts of phosphoric acid are alkali metal salts.

4. The method of claim 2, wherein the phosphate salt is a trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

5. The method of claim 2, wherein one phosphate is combined with an additional heavy metal complexing agent including Portland cement, calcium oxide, magnesium oxide, iron, calcium, calcium chloride, potassium chloride, sodium chloride, chlorides, aluminum, sulfates, surfactants, silicates, precipitants, coagulants, reducing agents, oxidizing agents and combinations thereof.

6. The method of claim 1, wherein the complexing agents are selected from the non-phosphate group including polymers, silicates, calcium oxide, quicklime, magnesium oxides, surfactants, calcium chloride, sodium chloride, potassium chloride, vanadium, boron, iron, aluminum, sulfates, reducing agents, oxidizing agents, flocculants, coagulants, precipitants, or combinations thereof.

7. A method of reducing the solubility and bioavailability of heavy metals within particulate emissions from air sources, comprising contacting heavy metal particulate with at least one water source and one complexing agent prior to the pollution particulate control device in an amount effective in reducing the leaching of heavy metal from particulate and thus reducing particulate solubility and bioavailability.

8. The method of claim 1, wherein the heavy metal complexing agent is selected from the group consisting of precipitants, coagulants, buffer agents, oxidizing agents, reducing agents, magnesium oxide, calcium oxide, Portland cement, iodide, potassium iodide, carbon, activated carbon, bone char, activated alumina, aluminum sulfate, potassium permanganate, ferric chloride, ferric sulfate, sulfides, carbonates, silicates, water soluble phosphates, water insoluble phosphates, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, monocalcium phosphate, monoammonia phosphate, diammonium phosphate, dicalcium phosphate, tricalcium phosphate, trisodium phosphate, salts of phosphoric acid, and combinations thereof.

9. A method of reducing the solubility and bioavailability of heavy metals within particulate emissions from air, wastewater and water sources, comprising contacting heavy metal particulate with at least one complexing agent prior to the pollution particulate control device and at a temperature above ambient in an amount effective in reducing the leaching of heavy metal from particulate and thus reducing particulate solubility and bioavailability.
